(19) United States
(12) Patent Application Publication
(10) Pub. No.: US 2020/0130346 A1
(43) Pub. Date: Apr. 30, 2020

(54) ROLLER DEVICE AND PRINTER

(71) Applicant: Panasonic Intellectual Property Management Co., Ltd., Osaka (JP)

(72) Inventor: TAKAFUMI SHINGAI, Kumamoto (JP)

(21) Appl. No.: 16/606,734

(22) PCT Filed: Apr. 20, 2018
(86) PCT No.: PCT/JP2018/016254

§ 371 Date: Oct. 18, 2019

(30) Foreign Application Priority Data
May 18, 2017 (JP) 2017-099345

(51) Int. Cl. B41F 31/00; B41F 31/26

(52) U.S. Cl. CPC B41F 31/002; B41F 31/26

(57) ABSTRACT

A roller device includes a cylindrical body, a thermoelectric converter, a first heatsink and a second heatsink that are disposed adjacent to each other, and a press-fitting member. The thermoelectric converter is disposed on an inner peripheral surface of the cylindrical body. The first heatsink and the second heatsink each dissipate heat of the thermoelectric converter. The press-fitting member is disposed between the first heatsink and the second heatsink. The press-fitting member makes the thermoelectric converter be held between the cylindrical body and at least one of the first heatsink and the second heatsink.

### TECHNICAL FIELD

The present disclosure relates to a roller device that can control temperature by using a thermoelectric converter such as a Peltier element and relates to a printer including the roller device.

### BACKGROUND

Conventionally, in an offset printer of the flat plate method, there are used various types of rollers such as an ink roller, a plate cylinder, a blanket, and an impression cylinder. Regarding the ink roller among these rollers, a plurality of ink rollers are disposed between an ink storage to the plate cylinder to guide ink from the ink storage to the plate cylinder while being in rotational contact with ink. During this operation, temperature of each ink roller rises due to frictional heat between the roller and the ink. Therefore, the temperature of the ink rollers needs to be appropriately controlled to a temperature in conformity with a specification of the ink.

PTL 1 describes a configuration in which a ventilation device is used to flow air inside the ink roller to cool the ink roller. In more detail, the cylinder is configured by fitting an inner cylinder into an outer cylinder. On an inner peripheral surface of the inner cylinder, there are formed a plurality of heat dissipation fins. Further, on an outer circumferential surface of the inner cylinder, there are disposed electronic cooling elements. The outer cylinder is configured such that an inner diameter of the outer cylinder becomes large when the outer cylinder is heated. After the outer cylinder is expanded by heating, the inner cylinder whose outer circumferential surface is provided with the electronic cooling elements is inserted and fitted into the outer cylinder. After that, the outer cylinder shrinks by being cooled. In this manner, surfaces of the electronic cooling elements come into close contact with an inner peripheral surface of the outer cylinder by letting an inner diameter of the outer cylinder be small.

### CITATION LIST

### Patent Literature

PTL 1: Unexamined Japanese Patent Publication No. 115-301336

### SUMMARY

A first aspect of the present disclosure relates to a roller device. A roller device according to the first aspect includes a cylindrical body, a thermoelectric converter, a first heatsink and a second heatsink that are disposed adjacent to each other, and a press-fitting member. The thermoelectric converter is disposed on an inner peripheral surface of the cylindrical body. The first heatsink and the second heatsink each dissipate heat of the thermoelectric converter. The press-fitting member is disposed between the first heatsink and the second heatsink. The press-fitting member makes the thermoelectric converter be held between the cylindrical body and at least one of the first heatsink and the second heatsink.

In the roller device according to present aspect, by a really simple work, for example, by inserting a press-fitting member between the adjacent heatsinks, the heatsinks and a thermoelectric converter can be smoothly disposed in a cylindrical body.

A second aspect of the present disclosure relates to a printer. The printer according to the second aspect includes the roller device according to the first aspect and transfers ink onto a sheet-shaped print medium by using the roller device.

Since the printer according to the present aspect includes the roller device according to the first aspect, the same effect as in the first aspect can be provided.

As described above, the present disclosure can provide a roller device in which a thermoelectric converter and heatsinks can be smoothly disposed inside the cylindrical body by a simple work, and can provide a printer using the roller device.

An effect or a meaning of the present disclosure will be further clarified in the following description of the exemplary embodiment. However, the exemplary embodiment shown below is merely one example of implementation of the present disclosure, and the present disclosure is not at all limited to the example described in the following exemplary embodiment.

### BRIEF DESCRIPTION OF DRAWINGS

FIG. 1 is a diagram schematically illustrating a configuration of a printer according to an exemplary embodiment.

FIG. 2A is a side view schematically illustrating a configuration, of a printing unit according to the exemplary embodiment, near a plate cylinder.

FIG. 2B is a diagram schematically illustrating a printing method of the printing unit according to the exemplary embodiment.

FIG. 3A is a diagram illustrating a configuration of an ink roller according to the exemplary embodiment.

FIG. 3B is a diagram illustrating how the ink roller, according to the exemplary embodiment, is disposed on a frame.

FIG. 4 is a perspective view illustrating a configuration of a roller main body according to the exemplary embodiment when viewed from an entrance side of a cooling wind.

FIG. 5 is a perspective view illustrating a configuration of the roller main body according to the exemplary embodiment, in which the cylindrical body is omitted.

FIG. 6 is an exploded perspective view illustrating a heatsink on an upper side according to the exemplary embodiment and illustrating thermoelectric converters and heat pipes that are disposed on the heatsink.

FIG. 7 is a partially exploded perspective view illustrating the following members according to the exemplary embodiment: a structure body configured with the heatsink on the upper side, thermoelectric converters, and heat pipes; and press-fitting members.

FIG. 8A is a perspective view illustrating a configuration of the thermoelectric converter according to the exemplary embodiment.

FIG. 8B is a perspective view illustrating a configuration of the thermoelectric converter according to the exemplary embodiment before a second substrate is attached.

FIG. 9A is a perspective view illustrating a partially enlarged view of an electrode group arranged on a first substrate according to the exemplary embodiment.

FIG. 9B is a perspective view illustrating how the thermoelectric converting elements are connected when the thermoelectric converting elements are arranged on the electrode group of FIG. 9A.

FIG. 10A is a side view illustrating a state of the roller main body before the press-fitting members according to the exemplary embodiment are inserted.

FIG. 10B is a side view illustrating the state of the roller main body when the press-fitting members according to the exemplary embodiment are inserted.

FIG. 11A is a transparent view schematically illustrating a state of an inside of the cylindrical body when the press-fitting member is inserted from only one side of the heatsinks according to the exemplary embodiment.

FIG. 11B is a transparent view schematically illustrating the state of the inside of the cylindrical body when the press-fitting members are simultaneously inserted from both sides of the heatsinks according to the exemplary embodiment.

FIG. 11C is a transparent view schematically illustrating the state of the inside of the cylindrical body when the press-fitting members are simultaneously inserted from both sides of the heatsinks according to the exemplary embodiment.

FIG. 12A is a diagram schematically illustrating a state where an end edge of a groove is deformed and widened due to the insertion of the press-fitting member according to the exemplary embodiment.

FIG. 12B is a diagram schematically illustrating a state of the end edge, of the groove, on a side opposite to an insertion side when the press-fitting member is inserted from only one side of the heatsinks.

FIG. 13A is a side view illustrating a state of the roller main body when press-fitting members according to a first modified example is inserted.

FIG. 13B is a side view illustrating a state of the roller main body when press-fitting members according to a second modified example is inserted.

FIG. 14A is a side view illustrating a state of the roller main body when press-fitting members according to a third modified example is inserted.

FIG. 14B is an enlarged partial side view illustrating a shape of a groove according to a fourth modified example.

FIG. 14C is an enlarged partial side view illustrating a guide groove according to a fifth modified example.

FIG. 15A an enlarged partial side view illustrating how a press-fitting member according to a sixth modified example is inserted.

FIG. 15B an enlarged partial side view illustrating how a press-fitting member according to a seventh modified example is inserted.

### DESCRIPTION OF EMBODIMENT

Before an exemplary embodiment of the present disclosure is described, problems with the conventional art will be briefly described. In the configuration of PTL 1 described above, cumbersome and time-consuming work such as heating and cooling the outer cylinder is required when the inner cylinder is attached to the outer cylinder. Further, since the inner cylinder provided with the electronic cooling elements is fit into the outer cylinder, it is extremely difficult to appropriately fit the inner cylinder into the outer cylinder.

In view of the above, the present disclosure provides a roller device in which a thermoelectric converting element and heatsinks can be smoothly disposed inside a cylindrical body by a simple work, and provides a printer using the roller.

Hereinafter, the exemplary embodiment of the present disclosure will be described with reference to the drawings. For the sake of convenience, X-axis, Y-axis, and Z-axis which are perpendicular to each other are added to the drawings. Note that in the following description, the term “ink” in the terms “ink roller” has the same meaning as “ink”.

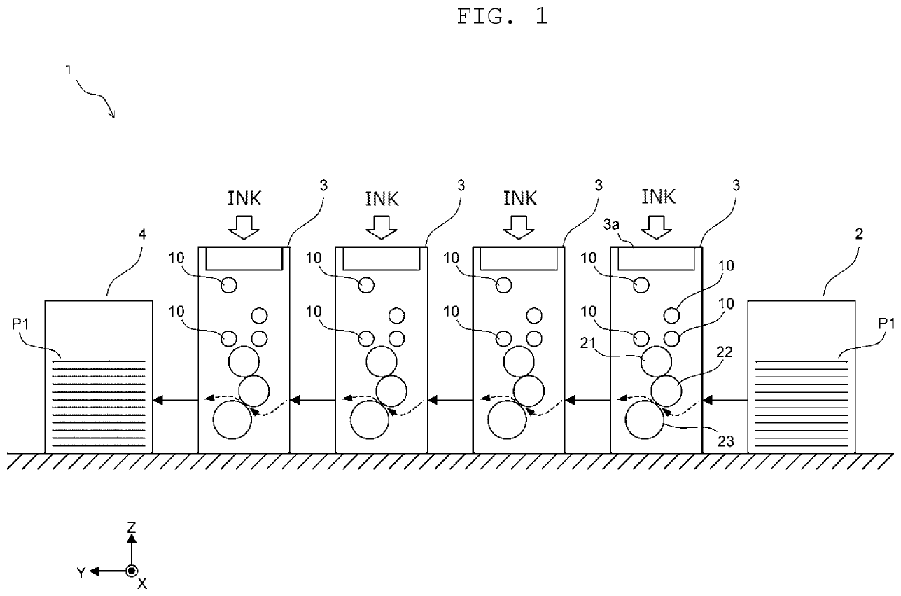

FIG. 1 is a diagram schematically illustrating a configuration of printer 1. Here, a configuration example of printer 1 configured to perform printing on one side of printing paper P1 is shown.

As shown in FIG. 1, printer 1 includes paper feed unit 2, four printing units 3, and accumulation unit 4. Paper feed unit 2 stores printing paper P1 of a predetermined size, which is a print medium, and feeds stored printing paper P1 in sequence to printing unit 3 on the most Y-axis negative side. Printing paper P1 sent out from paper feed unit 2 is transferred in sequence to four printing units 3 by a conveying mechanism of each printing unit 3.

Each of four printing units 3 prints a pattern image in a predetermined color on printing paper P1 sent out from paper feed unit 2. For example, each of four printing units 3 prints a pattern image in each of yellow, cyan, magenta, and black on printing paper P1.

Each of three printing units 3 on the Y-axis negative side feeds printing paper P1 having been printed to adjacent printing unit 3 in a Y-axis positive direction by the conveying mechanism. Printing unit 3 on the most Y-axis positive side sends out printing paper P1 after printing to accumulation unit 4 by the conveying mechanism. Accumulation unit 4 conveys sent-out printing paper P1 to an accumulation part in sequence. In this manner, printing paper P1 having been printed in all the colors is accumulated in accumulation unit 4.

Each of four printing units 3 has a similar configuration to each other. Each printing unit 3 includes ink storage 3a for storing ink of a corresponding color. Each printing unit 3 includes four ink rollers 10, plate cylinder 21, blanket 22, and impression cylinder 23. Ink rollers 10, plate cylinder 21, blanket 22, and impression cylinder 23 each have a columnar shape, and rotate about a rotation axis parallel to an X-axis in a direction parallel to a Y-Z plane.

Four ink rollers 10 guide ink from ink storage 3a to plate cylinder 21 while being in rotational contact with the ink. In this manner, the ink guided to plate cylinder 21 is transferred to an outer circumferential surface of plate cylinder 21 in a predetermined drawing pattern. The ink transferred to the outer circumferential surface of plate cylinder 21 is transferred to blanket 22 at a contact position between plate cylinder 21 and blanket 22. The ink thus transferred to blanket 22 is printed on printing paper P1 fed between blanket 22 and impression cylinder 23.

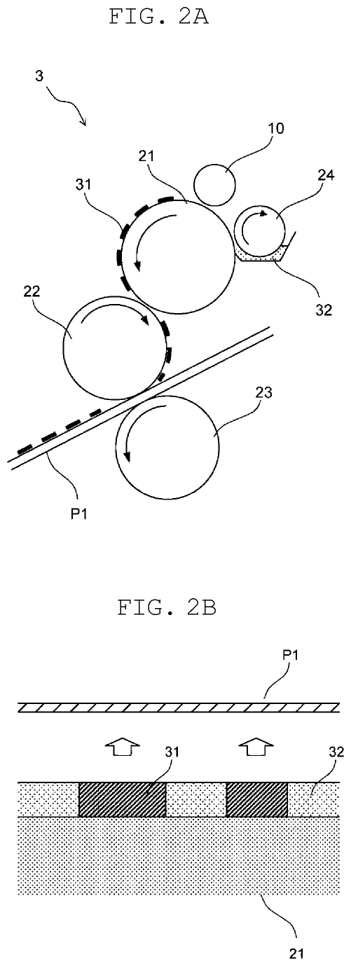

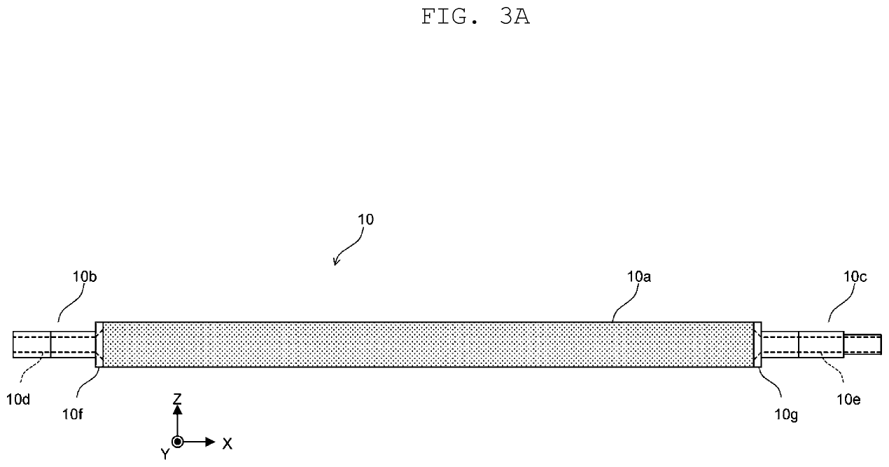

FIG. 2A is a side view schematically illustrating a configuration of printing unit 3 near plate cylinder 21. FIG. 2B is a diagram schematically illustrating a printing method of printing unit 3.

As shown in FIG. 2A, printing unit 3 further includes water roller 24 at a position close to plate cylinder 21. Water roller 24 applies water 32 along the outer circumferential surface of the plate cylinder 21. In this case, on the outer circumferential surface of plate cylinder 21, there is previously mounted a plate for image formation. The plate is so configured that water is attached to a non-image-forming region. Therefore, the water applied to the outer circumferential surface of plate cylinder 21 by water roller 24 remains only in the non-image-forming region and does not remain in the image-forming region. Therefore, ink 31 guided to the outer circumferential surface of plate cylinder 21 from ink roller 10 is adhered only to the image-forming region, in which no water remains, of the outer circumferential surface of plate cylinder 21.

FIG. 2B shows a state where ink 31 and water 32 are adhered to the outer circumferential surface of plate cylinder 21. Ink 31 thus transferred to the outer circumferential surface of plate cylinder 21 is transferred to blanket 22 as described above, and is then transferred to printing paper P1. In this manner, a pattern image corresponding to the plate mounted on the outer circumferential surface of plate cylinder 21 is printed on printing paper P1.

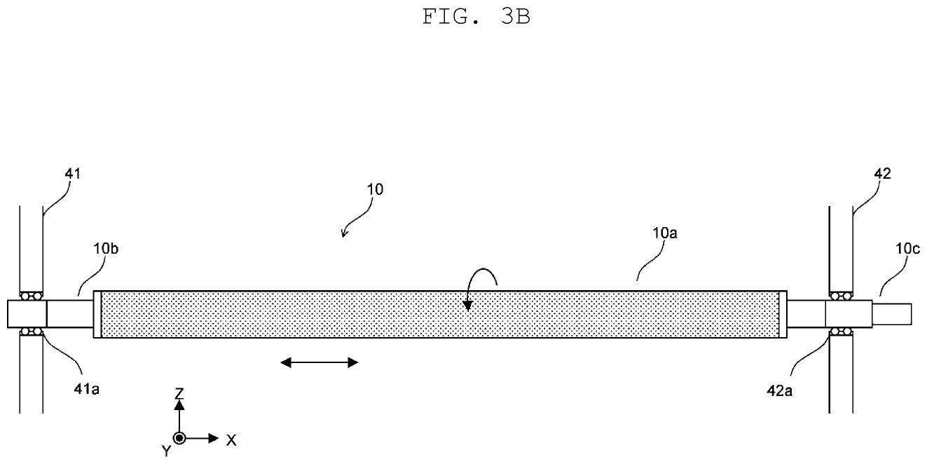

FIG. 3A is a diagram illustrating a configuration of ink roller 10.

Ink roller 10 includes roller main body 10a, and support members 10b, 10c. Roller main body 10a is constituted by a columnar structure body. An outer circumferential surface of roller main body 10a comes into contact with the ink. Support members 10b, 10c are cylindrical members, and respectively have holes 10d, 10e penetrating through in an X-axis direction. Support members 10b, 10c have a shape symmetric with respect to a central axis parallel to the X-axis. Support members 10b, 10c are each made of a metallic material. Support members 10b, 10c are mounted on roller main body 10a in such a manner that circular flanges 10f and 10g cover both ends of roller main body 10a.

FIG. 3B is a diagram illustrating how ink roller 10 is mounted on frames 41, 42 of printer 1. For the sake of convenience, in FIG. 3B, junctions between frames 41, 42 and support members 10b, 10c are shown transparently in a Y-axis direction.

Ink roller 10 is supported by frames 41, 42 with support members 10b, 10c being fit into bearings 41a and 42a. Ink roller 10 is movable in the X-axis direction and is rotatable about an axis parallel to the X-axis, respectively. Ink roller 10 is driven in the X-axis direction by a drive mechanism (not shown), and is rotated about the axis parallel to the X-axis. In this manner, damping water (diluting liquid) is supplied to the outer circumferential surface of ink roller 10 while ink roller 10 is being driven, so that the damping water is mixed with the ink being in contact with ink roller 10, and, as a result, the ink is adjusted to be in an appropriate emulsified state, which is in an appropriate viscosity.

Note that such an operation of ink roller 10 generates frictional heat between ink roller 10 and the ink, whereby a temperature of ink roller 10 is increased. On the other hand, because the ink used for printing is mainly ultraviolet curable ink, the ink has high viscosity and requires strict temperature control. In particular, when inexpensive ink, which requires high intensity ultraviolet irradiation for curing, is used, the viscosity of the ink is high, and frictional heat generated between ink roller 10 and the ink is accordingly high. This requires a configuration to efficiently remove heat generated in ink roller 10 and to thus adjust the temperature of ink roller 10 to a predetermined temperature accurately.

In view of the above, in the present exemplary embodiment, ink roller 10 includes a plurality of thermoelectric converters arranged on an inner peripheral surface of roller main body 10a. Thermoelectric converters are supplied with electric power through a slip ring (not shown). On heat dissipation surfaces of the thermoelectric converters, a heatsink is disposed. The heat generated on the outer circumferential surface of roller main body 10a is transferred to the heatsink by the thermoelectric converters. A ventilation device (not shown) causes cooling wind to flow inside roller main body 10a through support members 10b, 10c. This removes the heat transferred to the heatsink by the thermoelectric converters.

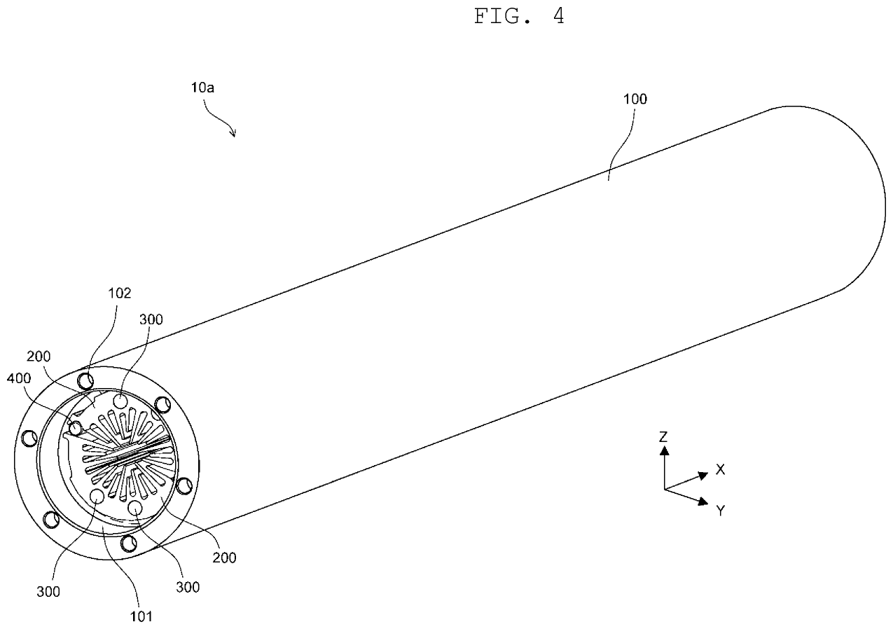

Hereinafter, a structure of roller main body 10a will be described with reference to FIGS. 4 to 10B.

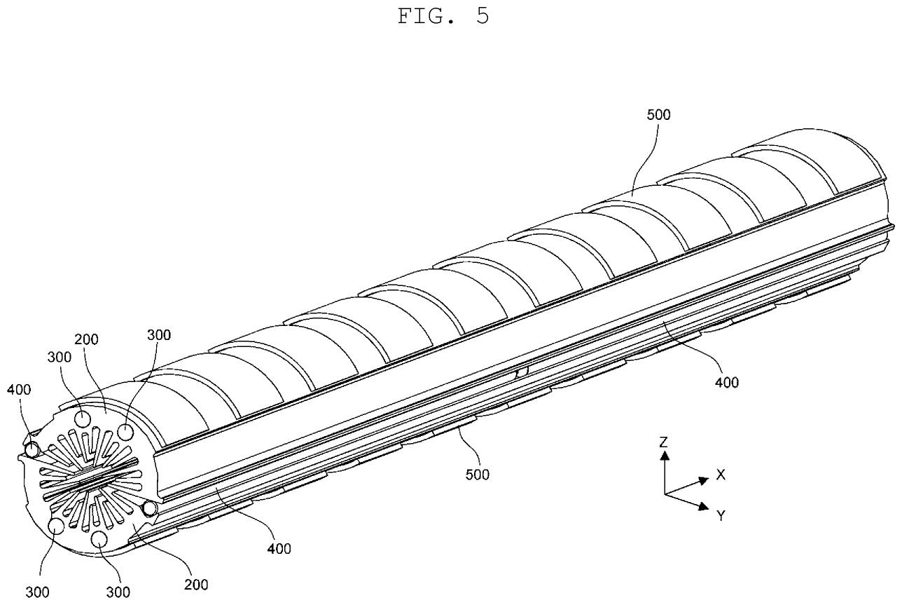

FIG. 4 is a perspective view illustrating the configuration of roller main body 10a when viewed from an entrance side of the cooling wind. FIG. 5 is a perspective view illustrating the configuration of roller main body 10a, in which cylindrical body 100 is omitted.

As shown in FIGS. 4 and 5, roller main body 10a includes cylindrical body 100, two heatsinks 200, four heat pipes 300, four press-fitting members 400, and a plurality of thermoelectric converters 500.

Cylindrical body 100 has a cylindrical shape and is made of a metallic material such as copper or aluminum, which is excellent in thermal conductivity. Alternatively, iron is used for cylindrical body 100 in some cases in consideration of strength of cylindrical body 100. In cylindrical body 100, circular through hole 101 passing through in the X-axis direction is formed. At an end part in an X-axis negative side and an end part in an X-axis positive side, through hole 101 has a diameter slightly larger than a diameter at the other part of through hole 101. Cylindrical body 100 has six bolt holes 102 in each of an end face on the X-axis negative side and an end face of the X-axis positive side. Bolt holes 102 are used for fixing support members 10b, 10c shown in FIG. 3A.

Heatsink 200 has a semi-columnar shape and is configured of a material such as copper or aluminum, which has an excellent thermal conductive property. Heatsink 200 has a length slightly shorter than a length of cylindrical body 100. Both of two heatsinks 200 have the same shape with each other. Two heatsinks 200 configure an approximately columnar structure body by stacking in up-down direction. An outer diameter of this columnar structure body is smaller than an inner diameter of cylindrical body 100.

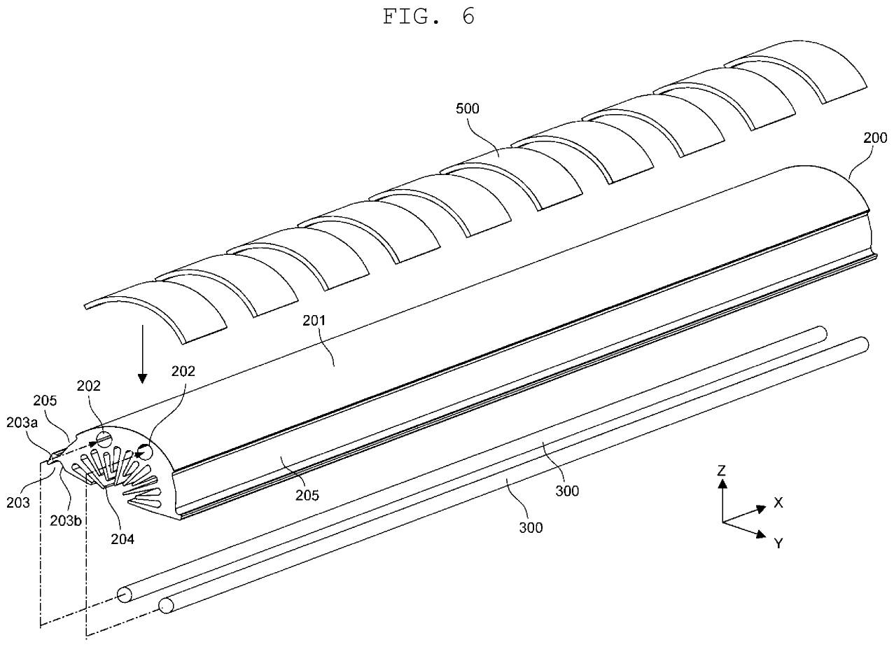

FIG. 6 is an exploded perspective view illustrating heatsink 200 on an upper side (Z-axis positive side) as well as thermoelectric converters 500 and heat pipes 300 that are mounted on this heatsink 200. Note that a configuration of heatsink 200 on a lower side (Z-axis negative side) and thermoelectric converters 500 and heat pipes 300 mounted on this heatsink 200 is similar to the configuration shown in FIG. 6.

In heatsink 200, top surface 201, two holes 202, groove 203, a plurality of fins 204, and two recesses 205 are integrally formed.

Top surface 201 is a circular arc-shaped curved surface. On top surface 201, ten thermoelectric converters 500 are provided at approximately equal intervals. As will be described later, each thermoelectric converter 500 can be curved in a direction parallel to the Y-Z plane. Thermoelectric converters 500 are disposed on top surface 201 with a bonding means such as adhesive or heat dissipation grease in a state where thermoelectric converters 500 are curved in a shape along top surface 201.

Two holes 202 have a circular cross-sectional shape, extend in the X-axis direction, and penetrate through heatsink 200. Each hole 202 has a diameter slightly larger than a diameter of heat pipe 300. Two holes 202 are provided at positions symmetric in the Y-axis direction. In each of two holes 202, heat pipe 300 is inserted and attached. Heat pipe 300 is inserted in hole 202 to extend from the vicinity of one end part of heatsink 200 in a longitudinal direction to the vicinity of the other end part. Specifically, heat pipe 300 extends over mounting positions of all ten thermoelectric converters 500 disposed on top surface 201 of heatsink 200.

Heat pipe 300 is provided in order to make temperature of top surface 201 of heatsink 200 uniform in the X-axis direction. In heat pipe 300, heat is transferred from a high temperature part to a low temperature part by an operating fluid circulating in heat pipe 300 while repeating vaporization and condensation. This approximately makes uniform the temperature of top surface 201 of heatsink 200. Since the temperature of top surface 201 is made uniform, the temperature of the heat dissipation surfaces of ten thermoelectric converters 500 is made to be approximately the same temperature, and cooling performances of all thermoelectric converter 500 can be maintained high.

Groove 203 is provided to regulate a position of press-fitting member 400. Groove 203 has an approximately V-shaped cross-sectional shape and extends in the X-axis direction from the end face of heatsink 200 on the X-axis negative side to the end face of the X-axis positive side. Groove 203 has two planar-shaped wall surfaces 203a, 203b for receiving press-fitting member 400. When a virtual plane parallel to an X-Z plane is set at the deepest position of groove 203, two wall surfaces 203a, 203b are inclined in an opposite direction to each other at almost the same angle with respect to this virtual plane. A bottom part of groove 203 is slightly rounded.

By a plurality of notches being approximately radially formed from a central position of a bottom surface of heatsink 200 in the Y-axis direction, a plurality of fins 204 are formed. Each fin 204 extends in the X-axis direction from the end face, on the X-axis negative side, of heatsink 200 to the end face on the X-axis positive side. The cooling wind flowing in the X-axis direction through gaps between these fins 204 removes the heat transferred from cylindrical body 100 to heatsink 200.

Recesses 205 are provided to draw out lead wires for supplying electric power to thermoelectric converters 500. Each recess 205 has a shape in which an outer circumferential surface of heatsink 200 is cut out in a circular arc shape. Each recess 205 extends in the X-axis direction from the end face, on the X-axis negative side, of heatsink 200 to the end face on the X-axis positive side. The lead wires drawn out from each thermoelectric converter 500 are drawn out to outside while being housed in recess 205.

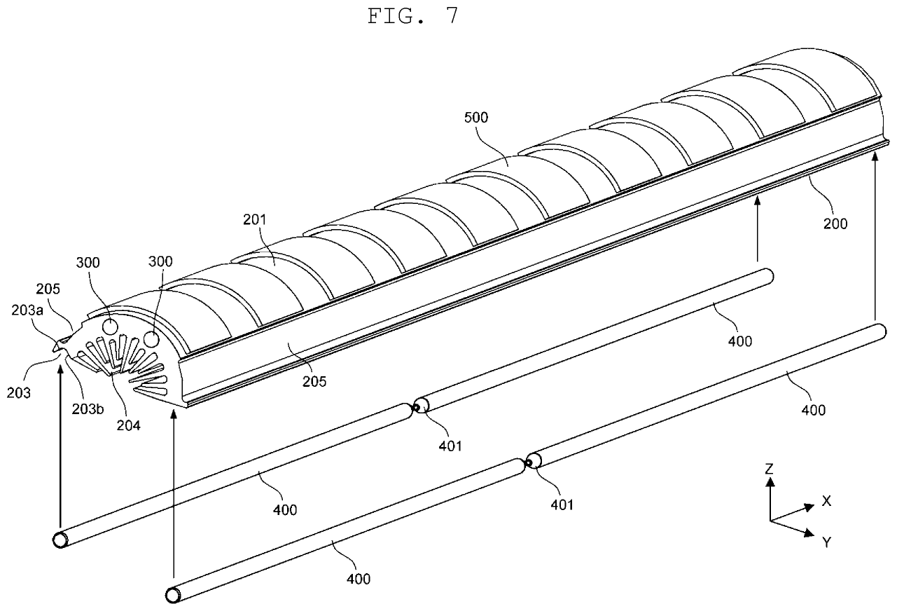

FIG. 7 is a partially exploded perspective view illustrating: a structure body configured with heatsink 200 on the upper side (Z-axis positive side), thermoelectric converters 500, and heat pipes 300; and press-fitting members 400.

Press-fitting members 400 are each made up of a rod-shaped member having a circular cross-section, and are each configured with a material such as stainless steel, which has high rigidity. In the present exemplary embodiment, four press-fitting members 400 are used. A length of each press-fitting member 400 is half a length of heatsink 200. Four press-fitting members 400 all have the same shape.

End part 401 of press-fitting member 400 in an insertion direction has a conical-shape (a tapered shape toward a tip), whose width becomes narrow toward the tip. Two press-fitting members 400 are disposed in one groove 203 of heatsink 200, being arranged in line in the X-axis direction. Therefore, two press-fitting members 400 disposed in line in the X-axis direction are disposed to cover approximately an entire range of heatsink 200 in a longitudinal direction. In other words, press-fitting members 400 are disposed in substantially the entire range of heatsink 200 in the longitudinal direction.

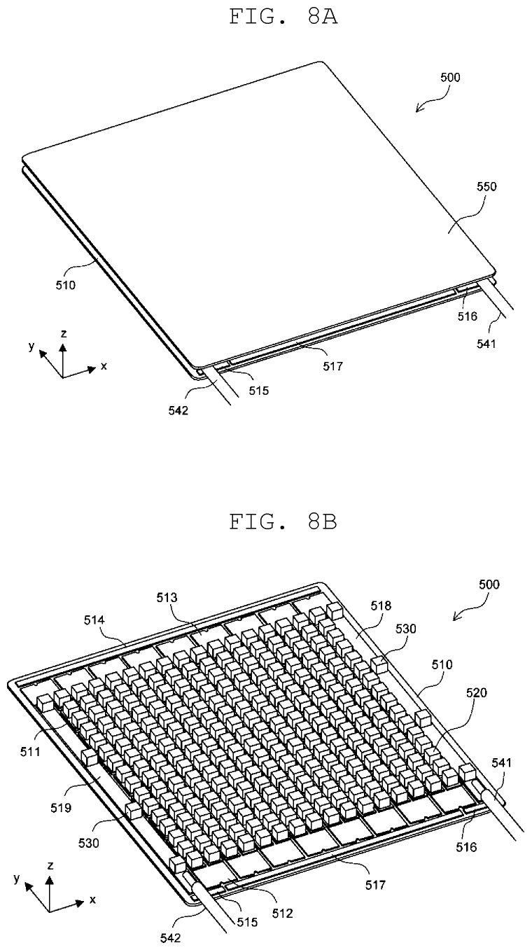

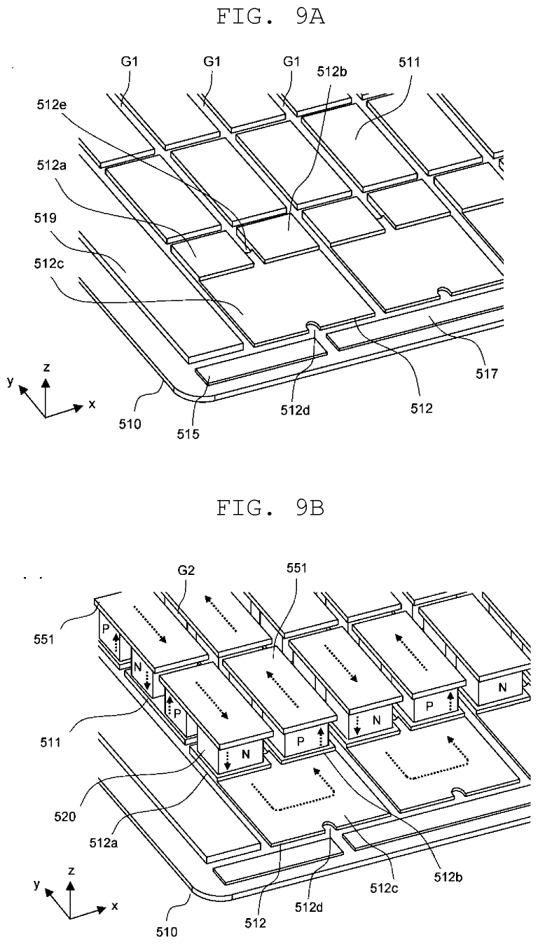

Next, a structure of thermoelectric converter 500 will be described with reference to FIGS. 8A to 9B. Note that for the sake of convenience, x-axis, y-axis, and z-axis which are perpendicular to each other are newly added to FIGS. 8A to 9B. An x-axis direction, a y-axis direction, and a z-axis direction are respectively correspond to a width direction, a length direction, and a thickness direction of thermoelectric converter 500.

FIG. 8A is a perspective view illustrating a configuration of thermoelectric converter 500, and FIG. 8B is a perspective view illustrating the configuration of thermoelectric converter 500 before second substrate 550 is attached. FIG. 9A is a perspective view illustrating a partially enlarged view of an electrode group arranged on first substrate 510, and FIG. 9B is a perspective view illustrating how thermoelectric converting elements 520 are connected when thermoelectric converting elements 520 are arranged on the electrode group of FIG. 9A.

Note that in FIG. 9B, each of P-type thermoelectric converting elements 520 is appended with the character “P”, and each of N-type thermoelectric converting elements 520 is appended with the character “N”. Further, in FIG. 9B, the broken line arrows each represent an electrical connection route. For the sake of convenience, in FIG. 9B, support members 530 are not shown, and electrodes 551 disposed on a lower surface of second substrate 550 are shown.

As shown in FIGS. 8A and 8B, thermoelectric converter 500 includes first substrate 510, thermoelectric converting elements 520, support members 530, lead wires 541, 542, and second substrate 550.

First substrate 510 and second substrate 550 have, in a plan view, a rectangular outline whose corners are rounded. First substrate 510 and second substrate 550 are made of a material that has an excellent thermal conductive property and are deformable. For example, a thin copper plate can be used as first substrate 510 and second substrate 550. Other than this material, first substrate 510 and second substrate 550 may be formed of, for example, aluminum, silicone resin, or epoxy resin.

As shown in FIGS. 8B and 9A, on an upper surface (a surface on the z-axis positive side) of first substrate 510, there is provided an electrode group constituted by electrodes 511 and bridging electrodes 512, 513. On edges of the upper surface of first substrate 510, there are provided first patterns 514 to 517 and second patterns 518, 519. Electrodes 511, bridging electrodes 512, 513, first patterns 514 to 517, and second patterns 518, 519 are formed of, for example, copper or aluminum. In a case where first substrate 510 is configured of a conductive material, a flexible insulating layer is provided between first substrate 510 and each of electrodes 511, bridging electrodes 512, 513, first patterns 514 to 517, and second patterns 518, 519.

To upper surfaces of electrodes 511 and bridging electrodes 512, 513, there are bonded lower surfaces of thermoelectric converting elements 520 with solder. To upper surfaces of second patterns 518, 519, there are bonded lower surfaces of support members 530 with solder. Further, to second patterns 518, 519, there are connected lead wires 541, 542 with solder. On first patterns 514 to 517, none of thermoelectric converting elements 520 and support members 530 is provided.

Electrodes 511 are arranged along a plurality of columns extending in a y-axis direction. Bridging electrodes 512, 513 are respectively disposed on an end on a y-axis negative side and on an end on a y-axis positive side so as to bridge two columns.

Bridging electrode 512 includes: two areas 512a, 512b; and area 512c connecting these areas 512a, 512b. Two areas 512a, 512b of bridging electrode 512 have the same thickness as electrodes 511. Area 512c of bridging electrode 512 has a smaller thickness and larger surface area than electrode 511. Areas 512a, 512b, 512c are integrally formed. Further, bridging electrode 512 has notches 512d, 512e inside bridging electrode 512, and notches 512d, 512e are each recessed in a circular arc shape toward inside and parallel to the y-axis direction. Notches 512d, 512e are formed on a separator line that separates adjacent columns, and are formed to be recessed along the separator line.

As shown in FIG. 8B, on edge parts on the y-axis positive side and on the y-axis negative side of the upper surface of first substrate 510, first patterns 514 to 517 are formed to extend in the x-axis direction. Further, on edge parts on the x-axis positive side and on the x-axis negative side of the upper surface of first substrate 510, second patterns 518, 519 are formed to extend in the y-axis direction. Second pattern 518 on the right side is integrally connected to bridging electrode 513 on the right most end, and second pattern 519 on the left side is integrally connected to bridging electrode 513 on the most left end. On the upper surface of first substrate 510, the electrode group and a group of patterns are disposed to be symmetric in the x-axis direction.

A thickness of first patterns 515 to 517 is slightly thinner than a thickness of areas 512c. First patterns 515 to 517 are for giving tension to first substrate 510 when first substrate 510 is bent in a direction parallel to an x-z plane. This configuration enables first substrate 510 to be smoothly bent in the direction parallel to the x-z plane.

Note that the thickness of first patterns 515 to 517 may be another thickness as long as first patterns 515 to 517 can apply a desired tension to first substrate 510. Further, the first patterns formed on the edge, of substrate 510, on the Y-axis negative side do not have to be separated into three parts in the x-axis direction and may be separated into another number of parts, or may not be separated like first pattern 514 formed on an end of first substrate 510 on the y-axis positive side.

A thickness of second pattern 519 is approximately the same as the thickness of areas 512a, 512b and electrodes 511. A width, in the x-axis direction, of second pattern 519 is approximately the same as a width, in the x-axis direction, of areas 512a, 512b and electrodes 511. Other than a function to connect lead wire 542 and thermoelectric converting elements 520 as described above, second pattern 519 has a function as a reinforcing function to make first substrate 510 less bendable in a direction parallel to a y-z plane.

Seven bridging electrodes 513 as central electrodes shown in FIG. 8B also have a similar configuration to bridging electrodes 512. These seven bridging electrodes 513 have a structure that is line-symmetric to bridging electrode 512 in the y-axis direction. Bridging electrode 513 on the leftmost side is integrally connected to second pattern 519, and bridging electrode 513 on the rightmost side is integrally connected to second pattern 518.

First pattern 514 on the y-axis positive side has the same thickness and width as first patterns 515 to 517 on the y-axis negative side. First pattern 514 on the y-axis positive side is, similarly to first patterns 515 to 517 on the y-axis negative side, for giving tension to first substrate 510 when first substrate 510 is bent in the direction parallel to the x-z plane. First pattern 514 on the y-axis positive side may be made of a plurality of parts separated in the x-axis direction. Further, second pattern 518 on the x-axis positive side has the same thickness and width as second patterns 519 on the x-axis negative side.

As shown in FIGS. 8B and 9B, on each electrode 511, two thermoelectric converting elements 520, which are each P type and N type, are disposed to be arranged in line in the y-axis direction. Further, on each of bridging electrodes 512, 513, two thermoelectric converting elements 520, which are each P type and N-type, are disposed to be arranged in line in the X-axis direction. On each of second patterns 518, 519, there are disposed four support members 530.

Thermoelectric converting elements 520 have an approximately cubic shape. Thermoelectric converting elements 520 are each made up of an element such as a Peltier element that controls heat by electric power. Support members 530 have a similar shape to thermoelectric converting elements 520. Support members 530 have a height that is the same as a height of thermoelectric converting elements 520. Support members 530 are each made of a highly rigid material. Support members 530 are each made of such a material that the patterns of first substrate 510 and second substrate 550 (see FIG. 6) can be soldered to an upper surface and a lower surface of each support member 530. For example, support members 530 can be configured of a zinc alloy. Alternatively, each support member 530 may be configured by plating a surface of a structure body made of metal, resin material, or other materials.

P-type thermoelectric converting elements 520 and N-type thermoelectric converting elements 520 that are disposed in line in the y-axis direction are series-connected by electrodes 511 and electrodes 551. Electrodes 551 are disposed on the lower surface of second substrate 550. Further, on the most y-axis negative side, P-type thermoelectric converting elements 520 and N-type thermoelectric converting elements 520 that are disposed in line in the x-axis direction are series-connected by bridging electrodes 512. Similarly, on the most y-axis positive side, P-type thermoelectric converting elements 520 and N-type thermoelectric converting elements 520 that are disposed in line in the x-axis direction are series-connected by bridging electrodes 513 (see FIG. 8B) on first substrate 510. In this manner, all thermoelectric converting elements 520 on first substrate 510 are series-connected between lead wires 541, 542.

Thermoelectric converter 500 having the above configuration is flexible in the direction parallel to the x-z plane. Specifically, first substrate 510 is flexible; and on first substrate 510 there are gaps G1 generated between the columns of electrodes 511 disposed in line in the y-axis direction as shown in FIG. 9A. Further, since each of bridging electrodes 512, 513 disposed on first substrate 510 has a small thickness and is provided with notches 512d, 512e, first substrate 510 can be easily bent at positions of the straight lines extending along gaps G1. Therefore, first substrate 510 can be bent in the direction parallel to the x-z plane, at the positions of the straight lines extending along gaps G1.

Further, second substrate 550 is also flexible; and on second substrate 550 there are gaps G2 generated between electrodes 511 disposed in line in the y-axis direction as shown in FIG. 9B. Therefore, second substrate 550 can also be bent in the direction parallel to the x-z plane, at the positions of the straight lines extending along gaps G2. As described above, first substrate 510 and second substrate 550 can be bent in the direction parallel to the x-z plane, at the positions of the straight lines extending along gaps G1 and G2, respectively. Therefore, thermoelectric converter 500 shown in FIG. 8A is flexible in the direction parallel to the x-z plane.

In the structure body shown in FIG. 5, thermoelectric converters 500 are provided (temporarily fixed) on top surface 201 of heatsink 200 with adhesive or the like in such a manner that thermoelectric converters 500 are bent along top surface 201 of heatsink 200. Lead wires 541, 542 are drawn out to outside while being housed in recesses 205 formed in the side surface of heatsink 200.

Next, an assembly process of roller main body 10a will be described.

First, as shown in FIG. 6, heat pipe 300 is attached to each of two holes 202 of heatsink 200, and ten thermoelectric converters 500 are disposed on top surface 201 of heatsink 200. By this process, the structure body shown in the upper part of FIG. 7 is formed. Also on another heatsink 200, sheet pipes 300 and thermoelectric converters 500 are disposed to configure the other structure body. The thus-configured two structure bodies are stacked on each other and inserted inside cylindrical body 100. Further, two press-fitting members 400 are inserted into each groove 203 of heatsink 200. In this manner, assembly of roller main body 10a is completed.

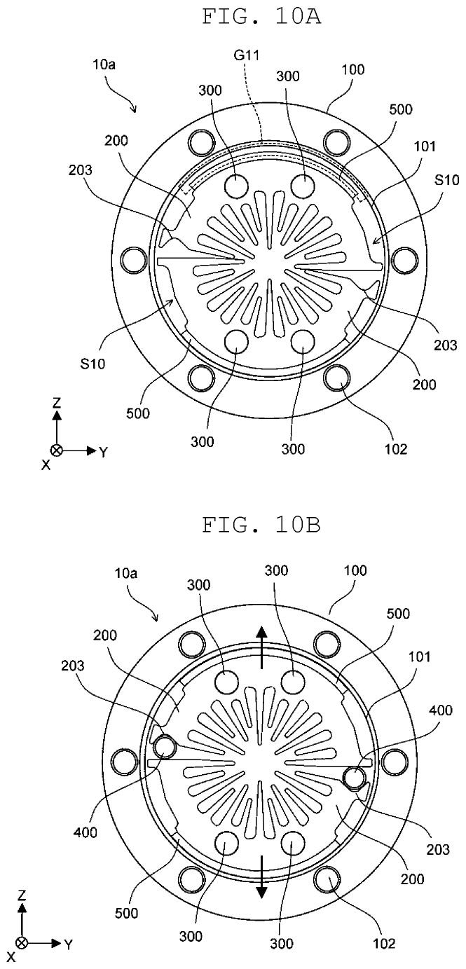

FIG. 10A is a side view illustrating roller main body 10a before press-fitting members 400 are inserted. Specifically, FIG. 10A shows a state where two structure bodies S10 each constituted by heatsink 200, heat pipes 300, and thermoelectric converters 500 are stacked on each other and inserted inside cylindrical body 100.

As shown in FIG. 10A, when two structure bodies S10 are stacked, a diameter of two structure bodies S10, which is defined from an outer circumferential surface of upper thermoelectric converters 500 to an outer circumferential surface of lower thermoelectric converters 500, is slightly smaller than the inner diameter of cylindrical body 100, which is a diameter of through hole 101. Hence, there is gap G11, which is shown by the broken line in FIG. 10A, between upper thermoelectric converters 500 and an inner peripheral surface of cylindrical body 100. Due to this gap G11, two structure bodies S10 can be smoothly inserted into through hole 101.

After two structure bodies S10, which are stacked on each other, are positioned at a predetermined position in through hole 101 in this manner, press-fitting members 400 are inserted into grooves 203 of heatsinks 200. In this case, for example, after two press-fitting members 400 are inserted into one of two grooves 203, two other press-fitting members 400 are inserted into another groove 203. Note that, two press-fitting members 400 may be inserted into each of both two grooves 203 simultaneously.

FIG. 10B is a side view illustrating roller main body 10a after press-fitting members 400 are inserted.

By inserting press-fitting members 400 into two grooves 203, a distance between two heatsinks 200 becomes wide. Accordingly, heatsink 200 on the upper side is displaced upward (positive direction in the Z-axis), so that upper thermoelectric converters 500 are pressed against the inner peripheral surface of cylindrical body 100. Further, reaction force applied from the inner peripheral surface of cylindrical body 100 to heatsink 200 on the upper side presses lower thermoelectric converters 500 against the inner peripheral surface of cylindrical body 100. In this manner, upper and lower thermoelectric converters 500 are each held between the inner peripheral surface of cylindrical body 100 and heatsinks 200 while being in close contact with the inner peripheral surface of cylindrical body 100.

In this case, the diameter of press-fitting member 400 is set so as to generate enough pressure to bring each of upper and lower thermoelectric converters 500 into close contact with the inner peripheral surface of cylindrical body 100 in the state shown in FIG. 10B.

Note that it is preferable that press-fitting members 400 be inserted into groove 203 simultaneously from both sides of heatsinks 200 in the longitudinal direction.

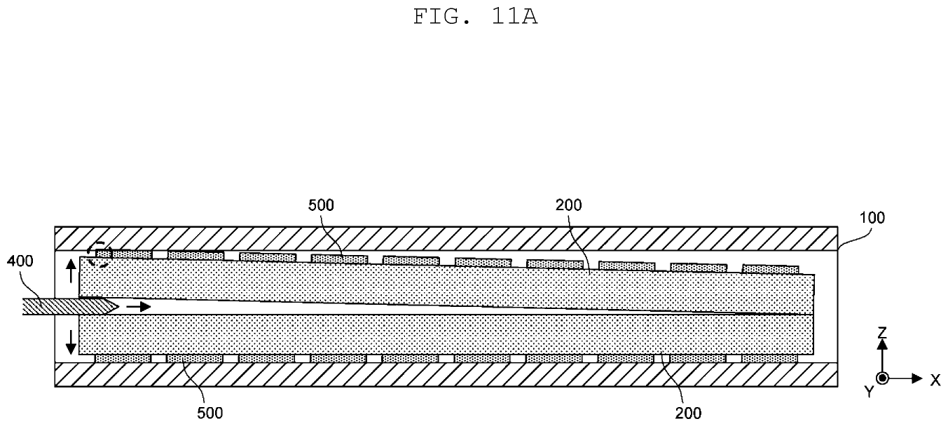

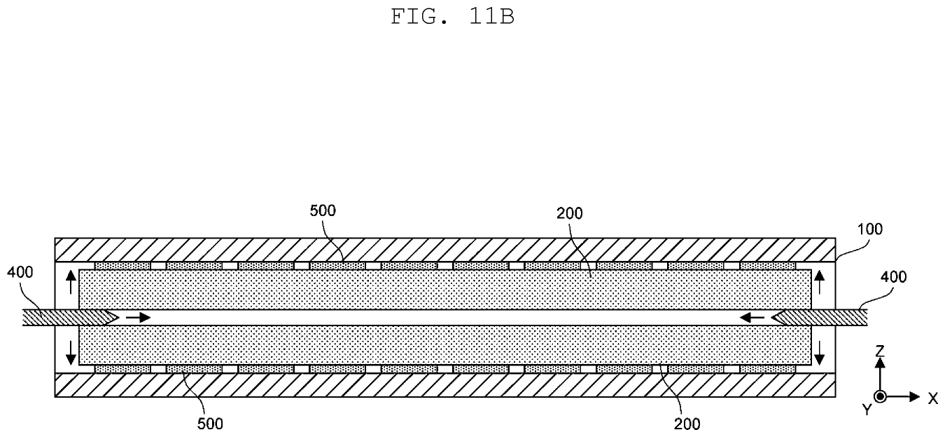

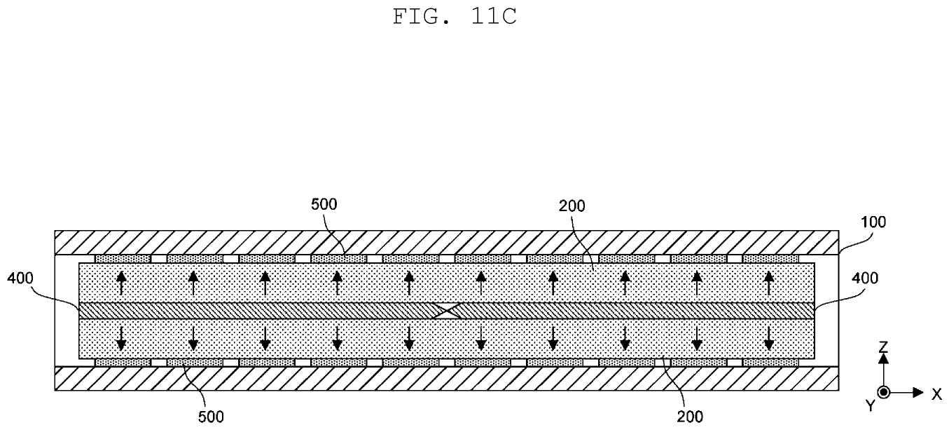

FIG. 11A is a transparent view schematically illustrating a state of the inside of cylindrical body 100 when press-fitting member 400 is inserted from only one side of heatsinks 200.

As shown in FIG. 11A, if press-fitting member 400 is inserted from only one side of heatsinks 200, an end part on an insertion side of heatsink 200 on the upper side is lifted up, and this heatsink 200 is inclined. Accordingly, a large load is locally applied to thermoelectric converters 500 disposed on the end part on the insertion side of heatsink 200. As a result, damage can be caused on such thermoelectric converters 500. The broken line circle in FIG. 11A represents the part to which the large load is locally applied.

FIGS. 11B and 11C are transparent views each schematically illustrating the state of the inside of cylindrical body 100 when press-fitting members 400 are simultaneously inserted from both sides of heatsinks 200.

In a case where press-fitting members 400 are inserted simultaneously from both sides of heatsinks 200 as shown in FIG. 11B, heatsink 200 on the upper side is evenly lifted up without being inclined. Therefore, a large load is not locally applied to any of thermoelectric converters 500, and a load is appropriately applied to all of thermoelectric converters 500 approximately evenly. As a result, damage cannot be caused on any of thermoelectric converters 500.

When press-fitting members 400 are completely inserted as shown in FIG. 11C, press-fitting members 400 are disposed in substantially the entire range of heatsinks 200 in the longitudinal direction. Therefore, in the entire range of the longitudinal direction, upper and lower heatsinks 200 are evenly pressed in up-down direction. Therefore, all of thermoelectric converters 500 disposed on each of upper and lower heatsinks 200 are pressed against the inner peripheral surface of cylindrical body 100 by an approximately uniform load. Therefore, all thermoelectric converters 500 are appropriately in close contact with the inner peripheral surface of cylindrical body 100. In this case, the expression “substantially the entire range” means a range that can exhibit an effect of evenly pressing upper and lower heatsinks 200 in the entire range of the longitudinal direction by inserting press-fitting members 400.

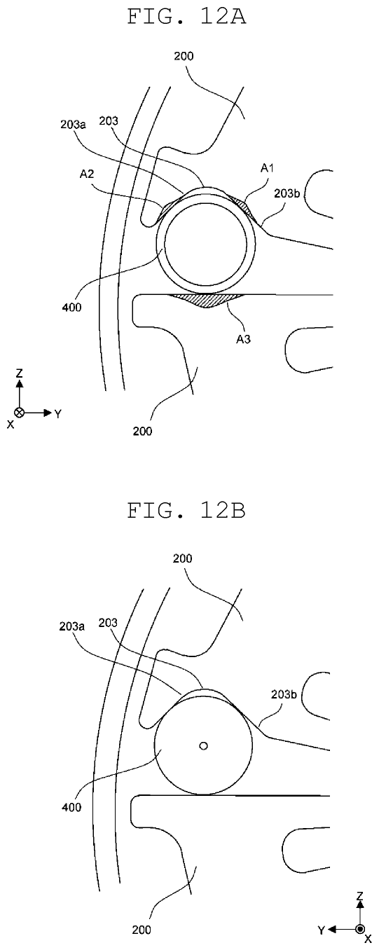

FIG. 12A is a diagram schematically illustrating how an end edge of groove 203 is deformed and widened due to the insertion of press-fitting member 400.

When press-fitting member 400 is inserted into groove 203 as shown in FIG. 12A, the end edge on the insertion side of groove 203 is deformed and widened by a large load applied at the time of starting insertion, and recesses A1, A2 are created on the end edge on the insertion side of groove 203. Similarly, also in a surface, of heatsink 200, facing groove 203 there is recess A3 created, due to a load, at a position on the end edge on the insertion side. Therefore, in the case where press-fitting members 400 are inserted into groove 203 from both side of heatsinks 200 as shown in FIGS. 11B and 11C, recesses A1, A2 due to the deformation at the time of insertion are created in the end edges on the both sides of groove 203 in the longitudinal direction, and, in addition, recesses A3 are created at positions approximately facing these recesses A1, A2.

FIG. 12B is a diagram schematically illustrating a state of the end edge, of groove 203, on a side opposite to an insertion side when press-fitting member 400 is inserted from only one side of heatsinks 200.

In the case where press-fitting member 400 is inserted into groove 203 from only one side of heatsinks 200, a load applied to the end edge, of groove 203, on the side opposite to the insertion side is not as large as the load applied to the end edge on the insertion side. Therefore, on the end edge, of groove 203, on the side opposite to the insertion side, two wall surfaces 203a, 203b are only slightly deformed due to the insertion of press-fitting member 400; and the end edge, of groove 203, on the side opposite to the insertion side is not so largely deformed to create recesses as the other part of groove 203.

As described above, depending on whether press-fitting members 400 are inserted from the both sides of heatsinks 200 or inserted from only one side, the end edges on the both sides of groove 203 are widened differently. In the case where press-fitting members 400 are inserted into groove 203 from the both sides of heatsinks 200 as shown in FIGS. 11B and 11C, the both end edges of groove 203 are widened compared with the other part of groove 203 because of deformation due to insertion of press-fitting members 400, so that recesses A1, A2 are created in the both end edges of groove 203. Therefore, from how the end edges on the sides of groove 203 are widened, it can be seen whether press-fitting members 400 are inserted from the both sides of heatsinks 200 or inserted from only one side.

### <Advantageous Effects of Exemplary Embodiment>

The present exemplary embodiment provides the following effects.

As already described with reference to FIGS. 10A and 10B, by a really simple work, for example, by inserting press-fitting member 400 between upper and lower heatsinks 200, heatsinks 200 and thermoelectric converters 500 can be smoothly disposed in cylindrical body 100.

As shown in FIG. 6, in each of upper and lower heatsinks 200, there is provided groove 203 for regulating a position of press-fitting member 400. Therefore, it is possible to smoothly insert press-fitting members 400 at predetermined positions without any positional displacement.

As shown in FIG. 7, each press-fitting member 400 is constituted by a rod-shaped member having a circular cross-section, and groove 203 receives press-fitting member 400 by two planar-shaped wall surfaces 203a, 203b that are inclined in an opposite direction to each other. Therefore, an area on which press-fitting member 400 is in contact with groove 203 at the time of insertion can be small, so that friction at the time of insertion can be made small. Therefore, press-fitting member 400 can be smoothly inserted into groove 203.

As shown in FIGS. 5, 10A, and 10B, groove 203 for regulating the position of press-fitting member 400 is provided in one of upper and lower heatsinks 200, and the flat surface is provided on the area, of the other of upper and lower heatsinks 200, facing groove 203. With this arrangement, when press-fitting member 400 is inserted, press-fitting member 400 and the flat surface come in slide-contact with each other. Hence, the position of heatsink 200 in a direction parallel to a boundary plane dividing between upper and lower heatsinks 200 can be adjusted. This can improve contactivity between the inner peripheral surface of cylindrical body 100 and thermoelectric converters 500, which are disposed between the inner peripheral surface of cylindrical body 100 and heatsinks 200.

As shown in FIG. 7, end part 401 of each press-fitting member 400 in the insertion direction has a conical-shape that is a tapered shape toward a tip. Therefore, end part 401 of press-fitting member 400 can be smoothly inserted into groove 203 at the time of insertion. Hence, as insertion of press-fitting member 400 proceeds, groove 203 can be smoothly displaced along the conical-shape of end part 401. Therefore, work at the time of insertion can be more easily performed.

As already described with reference to FIGS. 11B and 11C, by approximately simultaneously inserting press-fitting members 400 from the both sides of heatsinks 200 in the longitudinal direction, it is possible to prevent or reduce inclination of heatsink 200 at the time of insertion. Hence, it is possible to prevent or reduce damage to thermoelectric converters 500 caused by a large load applied to thermoelectric converters 500 disposed on heatsink 200. In this case, as already described with reference to FIGS. 12A and 12B, the fact that press-fitting members 400 are approximately simultaneously inserted from the both sides of heatsinks 200 in the longitudinal direction can be confirmed by recesses A1, A2 being created on each of the both end edges of groove 203 in the longitudinal direction. Here, recesses A1, A2 are created by deformation of the both end edges of groove 203 in the longitudinal direction being widened more than the other part of groove 203, which is caused by insertion of press-fitting members 400.

As shown in FIG. 7, two press-fitting members 400 aligned in the X-axis direction are disposed over substantially an entire range of heatsink 200 in the longitudinal direction. Therefore, as already described with reference to FIG. 11C, upper and lower heatsinks 200 are pressed apart in up-down direction evenly in the entire range in the longitudinal direction. Hence, all of thermoelectric converters 500 disposed on each of upper and lower heatsink 200 are pressed against the inner peripheral surface of cylindrical body 100 by an approximately uniform load. Therefore, all thermoelectric converters 500 can be appropriately in close contact with the inner peripheral surface of cylindrical body 100.

Note that, not limited to the case where two press-fitting members 400 are disposed for one groove 203 as in the above exemplary embodiment, the above effect can also exhibit in a case where one press-fitting member having the same length as the overall length of groove 203 is disposed for one groove 203, as well as in a case where three or more press-fitting members are disposed in one groove 203 so as to approximately cover the overall length of one groove 203. The present disclosure can include these forms.

In roller main body 10a according to the present exemplary embodiment, heatsinks 200 and thermoelectric converters 500 are fixed on cylindrical body 100 from inside of cylindrical body 100 by using press-fitting members 400. Hence, the outer circumferential surface of cylindrical body 100 can be a uniform and smooth curved surface over the entire circumference as shown in FIG. 4. Accordingly, ink can be uniformly distributed over the outer circumferential surface of roller main body 10a. Therefore, damping water and ink can be well kneaded, and a uniform ink film can be formed on plate cylinder 21.

### Modified Example

The exemplary embodiment of the present disclosure can be variously modified.

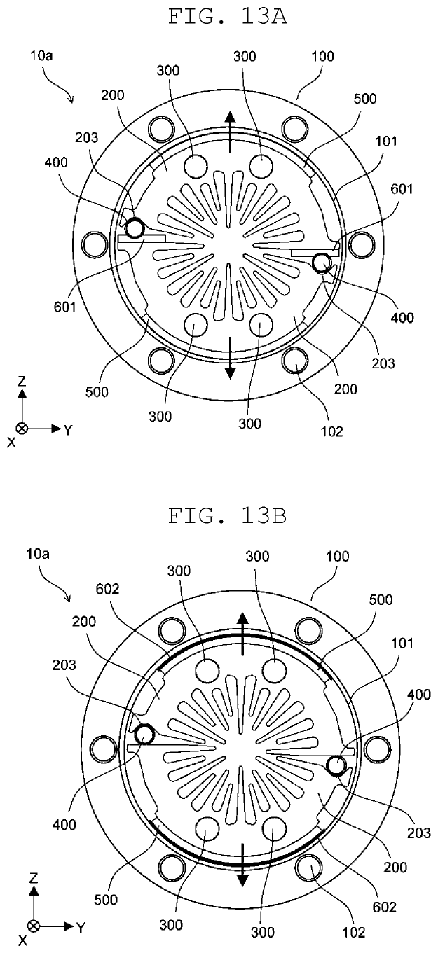

For example, elastic bodies 601 may be disposed between press-fitting members 400 and heatsinks 200 as shown in FIG. 13A, or elastic bodies 602 may be disposed between thermoelectric converters 500 and the inner peripheral surface of cylindrical body 100 as shown in FIG. 13B.

By disposing elastic bodies 601, 602 in this manner, it is possible to prevent or reduce the occurrence of pressing thermoelectric converters 500 against the inner peripheral surface of cylindrical body 100 by an excessive load even when there is a variation in the inner diameter of cylindrical body 100, the diameters of press-fitting members 400, or the like. Hence, thermoelectric converters 500 can be in close contact with the inner peripheral surface of cylindrical body 100 by an appropriate load.

In a first modified example of FIG. 13A, each of elastic bodies 601 is a plate-shaped member made of rubber, sponge, or the like, and has approximately the same length as groove 203. For example, each of elastic bodies 601 is fixed on a surface, of heatsink 200, facing corresponding groove 203 with an adhesive or the like. Further, in a second modified example of FIG. 13B, each of elastic bodies 602 is constituted by a heat dissipation sheet, a heat dissipation grill, or the like which are excellent in thermal conductivity, and are disposed over an approximately overall length of press-fitting member 400. Elastic bodies 601, 602 may be each divided in the X-axis direction.

Note that although elastic body 601 is disposed at each of the two positions facing grooves 203 in the first modified example of FIG. 13A, elastic body 601 may be disposed only at any one of the positions. Further, although each of elastic bodies 602 is disposed between thermoelectric converters 500 and the inner peripheral surface of cylindrical body 100 in the second modified example of FIG. 13B, each of elastic bodies 602 may be disposed between thermoelectric converters 500 and top surface 201 of heatsink 200.

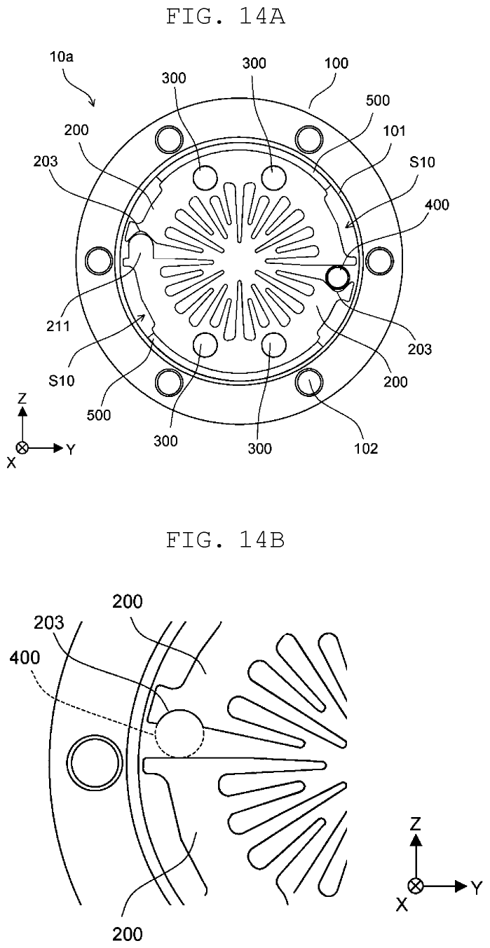

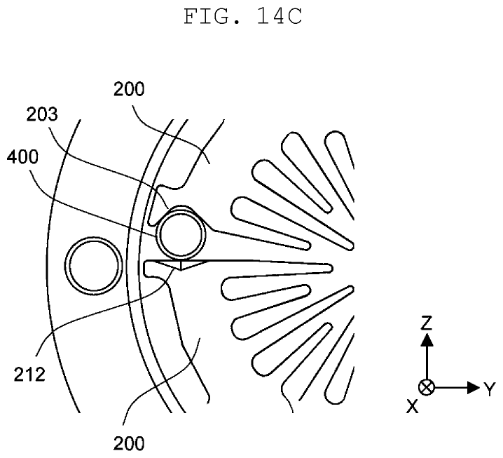

Alternatively, as shown in FIG. 14A, press-fitting member 400 inserted in groove 203 on the left side (on the Y-axis negative side) may be omitted, and projecting ridge 211 may be formed on an upper surface of lower heatsink 200 so as to be engaged in this groove 203. In this case, projecting ridge 211 extends in the X-axis direction along the approximately overall length of groove 203. An upper surface of projecting ridge 211 preferably has a circular arc shape when viewed in the X-axis direction such that a contact area between the upper surface and groove 203 is reduced.

In the third modified example of FIG. 14A, upper and lower structure bodies S10 are inserted into through hole 101 of cylindrical body 100 while being stacked such that projecting ridge 211 is engaged in groove 203. After that, press-fitting member 400 is inserted into groove 203 to configure roller main body 10a of FIG. 14A. Also in this case, as shown in FIGS. 11B and 11C, it is preferable to insert press-fitting member 400 simultaneously from the both sides of heatsinks 200.

In the third modified example of FIG. 14A, projecting ridge 211 is configured to be engaged in groove 203. Meanwhile, projecting ridge 211 and groove 203 may be replaced by a hinge, and upper and lower heatsinks 200 may be rotatably connected to each other by the hinge. In this case, it is not necessary to accurately align and stack two structure bodies S10 when two structure bodies S10 are inserted into through hole 101 of cylindrical body 100. Hence, a work of assembling roller main body 10a can be simpler.

Further, as shown in FIG. 14B, the shape of groove 203 when viewed in the X-axis direction may be a circular arc shape. Also in this modified example, since the insertion position of press-fitting member 400 is regulated by groove 203, press-fitting member 400 can be smoothly inserted at a predetermined position without any positional displacement. In addition to this shape, the shape of groove 203 may be another shape such as an elliptic arc shape.

Note that, in a fourth modified example of FIG. 14B, since a contact area between press-fitting member 400 and groove 203 is larger than in the case where groove 203 has a V shape having two planar-shaped wall surfaces 203a, 203b as shown in the above exemplary embodiment, friction between press-fitting member 400 and groove 203 is accordingly greater when press-fitting member 400 is inserted. Therefore, in the present modified example, it is difficult to insert press-fitting member 400 into groove 203 compared with the above exemplary embodiment. Accordingly, in order to perform insertion work more easily, groove 203 preferably has a V shape having two planar-shaped wall surfaces 203a, 203b as in the above exemplary embodiment.

Alternatively, as shown in FIG. 14C, groove 203 may be formed in one of upper and lower heatsinks 200, and guide groove 212 may be formed in an area, of another heatsink 200, facing the end edge on the insertion side of groove 203 such that guide groove 212 becomes shallower toward an insertion direction of press-fitting member 400. In this case, end part 401 of press-fitting member 400 can be inserted into groove 203 more smoothly. In a fifth modified example of FIG. 14C, the shape of guide groove 212 when viewed in the X-axis direction is a V shape. Meanwhile, the shape of guide groove 212 is not limited to the V shape and may be another shape such as a circular arc shape.

Note that guide groove 212 does not have to be provided in both of the areas each facing corresponding groove 203 and may be provided in only one of the areas. For example, in a case where, after press-fitting member 400 is inserted into one of two grooves 203, press-fitting member 400 is inserted into another groove 203, the gap between upper and lower heatsinks 200 can be widened at the position of the one of grooves 203, and press-fitting member 400 can be therefore inserted into this one groove 203 relatively easily. Therefore, in this case, guide groove 212 does not have to be particularly provided in the area facing this one groove 203, and guide groove 212 only has to be provided only in the area facing another groove 203.

Note that, in the above exemplary embodiment, groove 203 is formed at the insertion position of press-fitting member 400 in one heatsink 200, and another heatsink 200 has a flat surface with no groove provided. Meanwhile, groove 203 may be formed at a press-fitting position of press-fitting member 400 in each of the both heatsinks 200 so that press-fitting member 400 is held in each of two grooves 203.

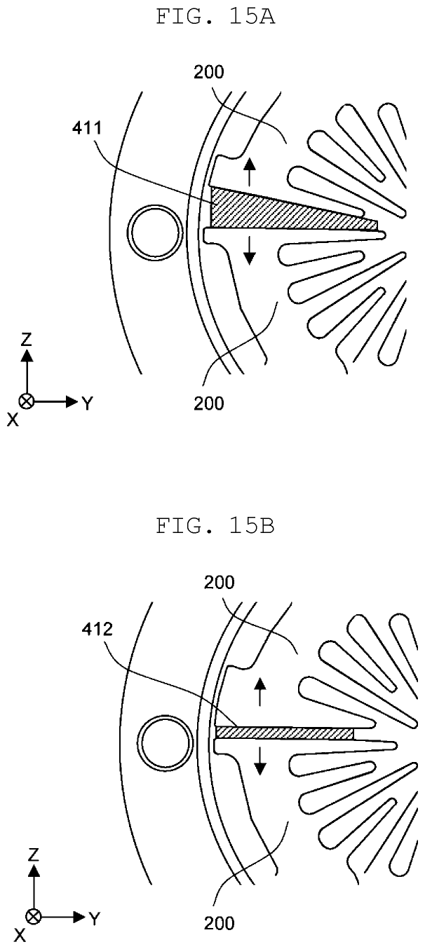

Further, as shown in FIGS. 15A and 15B, plate-shaped press-fitting members 411, 412 may be disposed between two heatsinks 200. In a sixth modified example of FIG. 15A, a shape of press-fitting member 411 when viewed in the Y-axis direction is a trapezoid. In a seventh modified example of FIG. 15B, a shape of press-fitting member 412 when viewed in the Y-axis direction is a rectangle that has longer side along the Y-axis direction. In the sixth and seventh modified examples of FIGS. 15A and 15B, groove 203 is provided on neither upper nor lower heatsinks 200.

In the sixth and seventh modified examples of FIGS. 15A and 15B, an end part, of each of press-fitting members 411, 412, on a front side in an insertion direction preferably have a shape whose width in the Z-axis direction become narrow toward a tip. This shape enables press-fitting members 411, 412 to be smoothly inserted into a gap between upper and lower heatsinks 200. Further, press-fitting members 411, 412 are preferably inserted between upper and lower heatsinks 200 from both sides in the longitudinal direction of heatsinks 200, and press-fitting members 411, 412 are preferably disposed in substantially in the entire range of heatsinks 200 in the longitudinal direction. Similar to the case of FIGS. 11B and 11C, this configuration enables thermoelectric converter 500 to prevent from being damaged and enables all thermoelectric converters 500 to be appropriately in close contact with the inner peripheral surface of cylindrical body 100.

In the above exemplary embodiment, two heatsinks 200 are disposed inside cylindrical body 100. Meanwhile, a number of heatsinks 200 disposed inside cylindrical body 100 is not limited to two, and the number may be three or more. In this case, not all of top surfaces 201 of heatsinks 200 have to be disposed with thermoelectric converters 500, but in order to improve cooling efficiency of ink roller 10, all of top surfaces 201 of heatsinks 200 are preferably disposed with thermoelectric converters 500. Further, press-fitting member 400 does not have to be inserted between all joint positions between adjacent two heatsinks 200, and a press-fitting member does not have to be inserted at a predetermined joint position as long as all of thermoelectric converters 500 can be appropriately in close contact with the inner peripheral surface of cylindrical body 100.

In the above exemplary embodiment, thermoelectric converters 500 can be deformable to be curved. Meanwhile, it is possible to use thermoelectric converters 500 that cannot be curved. In this case, for example, by using a first support member whose one surface is a flat surface and whose the other surface is a curved surface, and a second support member whose one surface is a curved surface and whose the other surface is a flat surface, thermoelectric converters 500 can be disposed on top surface 201 of heatsink 200. Here, the curved surface of the first support member is curved along top surface 201 of heatsink 200. And the curved surface of the second support member is curved along the inner peripheral surface of cylindrical body 100. Specifically, first, a unit including thermoelectric converters 500, the first support member, and the second support member is formed so that thermoelectric converters 500 are sandwiched between the flat surface of the first support member and the flat surface of the second support member. And then this unit is disposed on top surface 201 of heatsink 200 in such a manner that the curved surface of the first support member is in contact with top surface 201 of heatsink 200. With this configuration, thermoelectric converters 500 are disposed on the top surface of heatsink 200, being sandwiched between the first support member and the second support member. However, in this configuration, two support members are required to sandwich thermoelectric converters 500. Therefore, for a simpler configuration and higher working efficiency, it is preferable that thermoelectric converters 500 can be curved as in the above exemplary embodiment.

In the above exemplary embodiment, two press-fitting members 400 are inserted in one groove 203. Meanwhile, one or more than two press-fitting members 400 may be inserted in one groove 203. When a plurality of press-fitting members 400 are inserted in one groove 203, there may be a gap between adjacent press-fitting members 400.

In addition, heat pipe 300 may be omitted, as appropriate. A number of ink rollers 10 disposed on printing unit 3 is not limited to four. Other than the configuration for printing on one side of printing paper P1, printer 1 may be configured to print on both sides. In this case, a number of installed printing units 3 is changed as appropriate. Note that the present disclosure can be applied not only to ink rollers but also to other roller devices that can control cooling temperatures or heating temperatures.

The exemplary embodiment of the present disclosure can be modified in various manners as appropriate within the scope of the technical idea recited in the claims.

### REFERENCE MARKS IN THE DRAWINGS

1: printer
10: ink roller (roller device)
100: cylindrical body
200: heatsink
203: groove
203a, 203b: wall surface of groove
212: guide groove
400, 411, 412: press-fitting member
401: end part
500: thermoelectric converter
601, 602: elastic body

1. A roller device comprising:
a cylindrical body;
a thermoelectric converter disposed on an inner peripheral surface of the cylindrical body;
a first heatsink and a second heatsink that are adjacent to each other, the first heatsink and the second heatsink each dissipating heat of the thermoelectric converter; and
a press-fitting member disposed between the first heatsink and the second heatsink,
wherein the press-fitting member makes the thermoelectric converter be held between the cylindrical body and at least one of the first heatsink and the second heatsink.

2. The roller device according to claim 1, wherein:
the press-fitting member has a rod shape, and
the first heatsink has a groove to regulate a position of the press-fitting member.

3. The roller device according to claim 2, wherein:
the press-fitting member has a circular cross-section,
the groove has two wall surfaces each having a planar shape, the two wall surfaces being inclined to each other, and
the two wall surfaces receive the press-fitting member.

4. The roller device according to claim 2, wherein the second heatsink has an area facing the groove, the area being a flat surface.

5. The roller device according to claim 2, wherein an end part of the press-fitting member in an insertion direction has a shape whose width becomes narrow toward a tip.

6. The roller device according to claim 2, wherein:
the press-fitting member is inserted from one end edge of the groove, and
the second heatsink has a guide groove in an area facing the one end edge of the groove, the guide groove has a shape that gradually becomes shallow along a direction that the press-fitting member is inserted in.

7. The roller device according to claim 2, wherein:
the groove is formed from a first end part of the first heatsink to a second end part of the first heatsink in a longitudinal direction of the first heatsink,
a plurality of press-fitting members including the press-fitting member are disposed in the groove, and
the groove is deformed so that both end edges of the groove are wider than a part other than the both end edges by insertion of each of the plurality of press-fitting members.

8. The roller device according to claim 1, wherein the press-fitting member is disposed substantially in an entire range of at least one of the first heatsink and the second heatsink in a longitudinal direction of the at least one of the first heatsink and the second heatsink.

9. The roller device according to claim 7, wherein the plurality of press-fitting members are disposed substantially in an entire range of at least one of the first heatsink and the second heatsink in a longitudinal direction of the at least one of the first heatsink and the second heatsink.

10. The roller device according to claim 1, further comprising an elastic body disposed between the press-fitting member and the inner peripheral surface of the cylindrical body.

11. A printer comprising the roller device according to claim 1,
wherein the roller device is used to transfer ink to a sheet-shaped object to be printed.

12. The printer according to claim 11, wherein the roller device is an ink roller that leads ink from an ink storage to a plate cylinder.
